(19) United States
(12) Patent Application Publication
(10) Pub. No.: US 2025/0363904 A1
(43) Pub. Date: Nov. 27, 2025

(54) SYSTEM AND METHOD FOR DETERMINING MASTERY LEVEL OF A USER BASED ON CENTRALIZED DATA RECEIVED FROM EDUCATIONAL SOURCES

(71) Applicant: 2hr Learning, Inc., Austin, TX (US)

(72) Inventors: Samy Aboel-Nil, Austin, TX (US); Simon Said, Malta (MA); Bogdan Tenea, Bucharest (RO)

(73) Assignee: 2hr Learning, Inc., Austin, TX (US)

(21) Appl. No.: 19/218,359

(22) Filed: May 26, 2025

Related U.S. Application Data
(60) Provisional application No. 63/652,144, filed on May 27, 2024.

(51) Int. Cl. G09B 7/00

(52) U.S. Cl. CPC G09B 7/00

(57) ABSTRACT

A mastery level determining method to assess user mastery of educational skills by centralizing and processing data from diverse educational platforms is disclosed. The method involves collecting user educational data from various sources such as online learning platforms, external assessments, and internal quizzes. This data is then normalized to adapt to the educational standards and ingested into a structured mastery framework. The recent and reliable data is evaluated to determine skill mastery states, prioritizing newer and more reliable information. Subsequently, reliability and recency scores are calculated and assigned to each educational data. The method further categorizes user mastery skills into distinct states, providing an overview of the user's knowledge. The simplified mastery states and associated tags are accessible to the user, facilitating personalized learning experiences and assessments within the online learning platforms.

### CROSS-REFERENCE TO RELATED APPLICATION

This application claims the benefit under 35 U.S.C. § 119(e) and 37 C.F.R. § 1.78 of U.S. Provisional Application No. 63/652,144, filed May 27, 2024, which is incorporated by reference in its entirety.

### FIELD OF THE INVENTION

The present invention generally relates to the field of electronics, and more specifically to a system of determining whether the user has achieved mastery in a particular standard by receiving the mastery data of the user from different external educational sources and creating a unified knowledge graph of the user.

### BACKGROUND OF THE INVENTION

In today's educational landscape, students often utilize multiple online learning tools, internal school tests, and external assessments, each offering diverse educational content and evaluations. However, the challenge lies in consolidating and interpreting the mastery data scattered across these platforms. Traditionally, educators have had to navigate multiple systems to access and manage this data, leading to potential inconsistencies and inefficiencies in data management. This fragmented approach results in a disorganized view of a student's progress.

Moreover, relying solely on educators to manually interpret data from various sources introduces a diverse set of challenges. For example, the manual process is prone to errors, especially at scale, and can be subjective, impacting the accuracy of assessments and the quality of educational interventions. Alternative approaches, such as using simpler integration methods or traditional state-machine models, also fall short. These methods either cannot provide a comprehensive view of student mastery or become overly complex to adapt across different educational platforms.

However, attempts to tackle these issues using simpler integration methods or conventional state-machine models have been insufficient. Such approaches either fail to provide a unified view of student progress or introduce complexity that limits their adaptability and usability.

### SUMMARY

The present invention generally relates to a system of determining whether the user has achieved mastery in a particular standard by receiving the mastery data of the user from different external educational sources and creating a unified knowledge graph of the user.

In an embodiment, a method for determining whether the user has attained mastery or not by centralizing one or more user educational data from external educational sources is disclosed. The method comprises executing code using one or more processors of a computer system to cause the computer system to perform multiple operations. The operation initiates by collecting the one or more user educational data from the external educational sources. The one or more user educational data includes user mastery data from different online learning platforms, external assessments, internal quizzes, and so on. The collected user educational data is normalized by defining each educational data based on standards of an educational curriculum. The collected user educational data is ingested into a mastery structure to maintain uniformity across educational curriculums, and online learning platforms. The most recent and reliable user educational data is then evaluated by determining the current mastery state for each skill by prioritizing more recent and reliable data over older and less reliable data. Then, a reliability score and a recency score are calculated and assigned to each normalized educational data based on the trustworthiness, and timestamps of each educational data. The user's mastery skills are then categorized which are obtained from the normalized educational data to provide a clear representation of the user's knowledge level. The categorized states include unknown, learning, learned, and confirmed. Finally, a simplified mastery state and associated descriptive tag are received that are accessible to the user via. an API (Application Programming Interface) to an online learning platform for further use in personalized learning experiences and assessments of the user.

In another embodiment, a system to determine whether a user has attained mastery or not by centralizing one or more user educational data from external educational sources. The system comprises one or more processors, and one or more databases, operatively coupled to the one or more processors that when executed cause the one or more processors to perform multiple operations. The operations initiates by collecting the one or more user educational data from the external educational sources using a collector. The one or more user educational data includes user mastery data from different online learning platforms, external assessments, internal quizzes, and so on. The collected user educational data is then normalized using a normalization module by defining each educational data based on standards of an educational curriculum. The collected user educational data is ingested into a performance matrix to maintain uniformity across educational curriculums, and online learning platforms. The most recent and reliable user educational data is evaluated by determining the current mastery state for each skill by prioritizing more recent and reliable data over older and less reliable data using an evaluator. Then, a reliability score and a recency score are calculated using a reliability score calculator and a recency score calculator respectively and assigned to each normalized educational data based on the trustworthiness, and timestamps of each educational data, the user's mastery skills are then categorized by obtaining it from the normalized educational data to provide a clear representation of the user's knowledge level using a categorization module. The categorized states include unknown, learning, learned, and confirmed. Finally, a simplified mastery state and associated descriptive tags are received that are accessible to the user via. an API (Application Programming Interface) to an online learning platform for further use in personalized learning experiences and assessments of the user.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary mastery level determining system from a centralized mastery structure generated from educational data collected from external educational sources.

FIG. 2 depicts an exemplary mastery level-determining process from the centralized mastery structure generated from educational data collected from external educational sources.

FIG. 3 depicts a user mastery level establishing process from the centralized mastery structure generated from educational data collected from external educational sources, which is an embodiment of the mastery level determining process from the centralized mastery structure generated from external educational sources of FIG. 2.

FIG. 4 depicts a spreadsheet in which the details related to the educational curriculum are disclosed in tabular format.

FIGS. 5a and 5b depict a spreadsheet in which a truth table discloses the mastery level of the user.

FIGS. 6 and 7 depict exemplary user interfaces showing the knowledge level attained by a user through the mastery structure of a user.

FIGS. 8 and 9 depict an exemplary user interface showing the dependencies within the educational standards.

FIG. 10 depicts a mastery structure upgradation process using users' educational data 146 from different education platforms, which is an embodiment of the mastery level determining process from the centralized mastery structure generated from external educational sources of FIG. 2.

FIG. 11 depicts a student's mastery level communication process, which is an embodiment of the mastery level determining process from the centralized mastery structure generated from external educational sources of FIG. 2.

FIG. 12 depicts a student's mastery state and associated descriptive tags determining process which is an embodiment of the mastery level determining process from the centralized mastery structure generated from external educational sources of FIG. 2.

FIG. 13 depicts an updated knowledge graph generation process based on the educational data collected from the different educational platforms, which is an embodiment of the mastery level determining process from the centralized mastery structure generated from external educational sources of FIG. 2.

FIG. 14 depicts a data structure for organizing data to determine the mastery level of the user by collecting educational data from different educational platforms.

FIG. 15 depicts a data structure for organizing data to define the mastery and dependencies between the knowledge graph.

FIG. 16 depicts an exemplary network environment in which the system of FIG. 1 and the process of FIG. 2 may be practiced.

FIG. 17 depicts an exemplary computer system.

### DETAILED DESCRIPTION

A mastery level determining system to determine the mastery level of the user on various standards or topics by centralizing user educational data obtained from multiple educational platforms. The educational platforms include online learning apps, internal tests, and external assessments. The mastery level determining system includes a user educational data centralization module operatively coupled to an online learning platform. A collector integrated within the user educational data centralization module collects the user educational data from various educational platforms and provides it to a normalization module which standardizes and normalizes the user educational data in a structured and comprehensive format, thereby forming a mastery structure.

An evaluator is then used to evaluate the most recent and reliable user educational data by determining the current mastery state for each skill by prioritizing more recent and reliable data over older and less reliable data. A relevancy score calculator and a recency score calculator is used to calculate and assign the recency and relevance score to the educational data, respectively. Based on the score, a categorization module categorizes the mastery level of the user on various topics or standards into unknown, learning, learned, and confirmed states. The mastery status of the user is provided along with the associated tags which are accessible to the user on the online learning platform via. an API (Application Programming Interface).

The mastery level determining system from the centralized mastery structure generated from external educational sources offers significant advantages in education by centralizing and standardizing student mastery data across multiple platforms and assessments. By integrating educational data from learning apps, internal tests, and external assessments into a unified framework aligned with educational standards, the mastery level determining system from the centralized mastery structure generated from external educational sources provides educators with a comprehensive view of each student's learning progress. This approach not only enhances the accuracy of assessing mastery levels but also enables personalized recommendations and interventions, providing more effective teaching strategies in correspondence to the individual student needs.

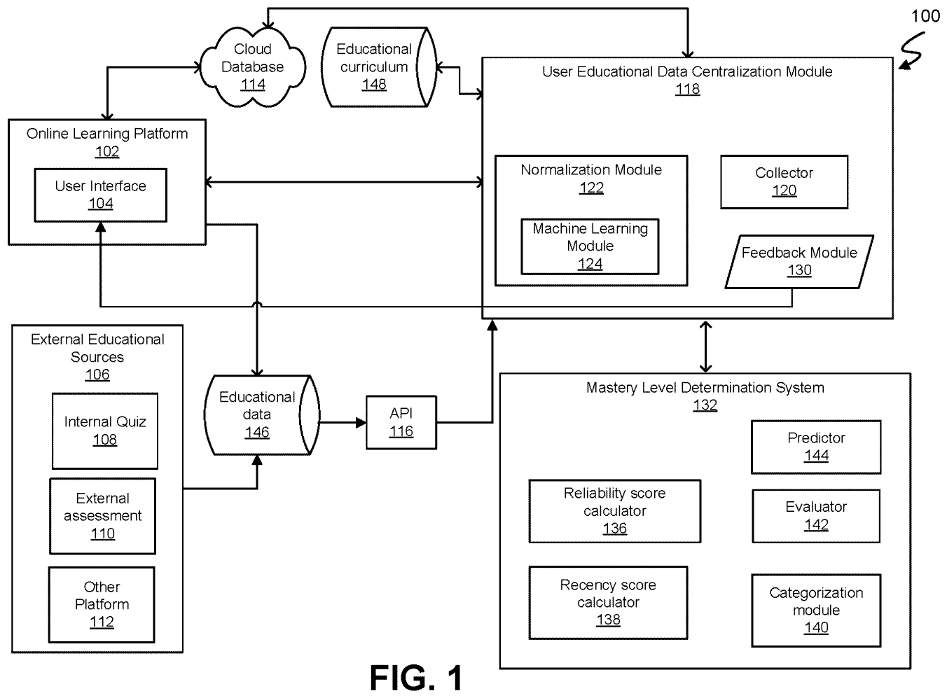

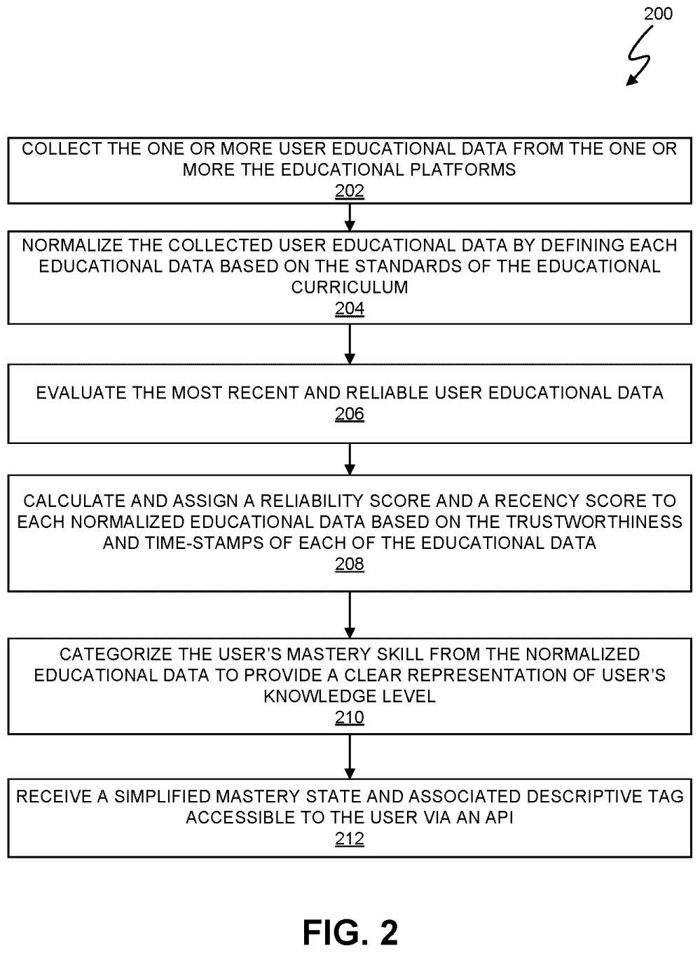

FIG. 1 depicts an exemplary mastery level determining system 100 from the centralized mastery structure generated from external educational sources 106. FIG. 2 depicts an exemplary mastery level determining process 200 from the centralized mastery structure generated from external educational sources 106 utilized by the mastery level determining system 100.

Referring to FIGS. 1 and 2, in operation 202, a collector 120 is configured to collect one or more educational data 146 from external educational sources 106. One or more educational data 146 is collected from various which includes internal quizzes 108, external assessments 110, and other online learning platforms 112. The internal quiz 108 may include tests, quizzes from school, or homework-based tests; the external assessments 110 may include the test conducted in some survey, external coaching, and so on; and the other online learning platforms 112 includes the test, quizzes, assessment-related data of the user using the online learning platform 102 or other learning platforms 112.

The user educational data 146 may include one or more topics studied by the user, questions attempted by the user, quizzes, or tests taken by the user on external educational sources 106. Further, the user's educational data 146 may include quizzes or tests attempted by the user outside the online learning platform environment.

Each piece of the user's educational data 146 is timestamped to maintain a chronological record, ensuring a user educational data centralization module 118 can accurately track the progression of the user's learning journey. The user educational data centralization module 118 is operatively coupled to the online learning platform 102 via. an API (Application Programming Interface). The online learning platform 102 and external educational sources 106 are operatively coupled to the user educational data centralization module 118 and provide user educational data 146 to the user using the collector 120.

The codes and functions mentioned in the pseudo-code of the mastery level determining system 100 from the centralized mastery structure generated from external educational sources 106 to retrieve data are explained below in correspondence to the above mentioned details.

The mastery level determining system 100 includes several Helper Functions to gather mastery data from different sources. ‘get_mastery_data_from_apps (skill_id, learning_apps)’ retrieves and returns mastery data from learning apps for a given skill, identified by ‘skill_id’. Similarly, ‘get_mastery_data_from_quizzes (skill_id, internal_tests)’ collects mastery data from internal tests 108, and ‘get_mastery_data_from_external_tests (skill_id, external_tests)’ gathers data from external tests 110. These functions are essential for extracting the necessary information from the various educational tools and tests.

This timestamping involves recording the exact date and time when each educational activity or assessment was completed. By doing so, the user educational data centralization module 118 creates a detailed timeline of the user's interactions with various learning platforms, quizzes, and external tests. The maintenance of chronological order allows distinguishing between older and newer data, which is essential when determining the current mastery state of a skill.

The codes and functions mentioned in the pseudo-code of the mastery level determining system 100 from the centralized mastery structure generated from external educational sources 106 to define constants are explained below in correspondence to the above mentioned details.

The global constants and threshold values section sets the basis for the mastery level determining system 100 by defining constants that will be used throughout the code. ‘recent_activity_threshold_days’ is set to 90 days, establishing a threshold for what constitutes recent activity. ‘source_reliability_scores’ assigns reliability scores to different sources of mastery data: 0.7 for learning apps, 0.9 for internal tests (quizzes), and 0.8 for external tests. These values help determine the trustworthiness of the data from each source.

Collecting educational data 146 from multiple educational platforms 106 involves utilizing the plurality of APIs 116 by the collector 120. The API (Application Programming Interface) 116, serves as a bridge that allows different software systems to communicate and exchange data efficiently. Here, collector 120 employs the API 116 provided to gather a detailed set of educational data 146 from multiple educational platforms 106. The API 116 connects the online learning platform 102, external educational source 106 with a user educational data centralization module 118.

By integrating with the API 116, the collector 120 can systematically retrieve a wide range of educational data 146, including user mastery data, quiz results, and test scores. This ensures that the data is collected in real-time or near-real-time, providing up-to-date information about the user's progress and performance.

The use of API 116 enables the collector 120 to compile a unified dataset from external educational sources 106. For example, the collector 120 can collect data from a popular learning app like Khan Academy, integrate results from internal school assessments, and gather scores from standardized external tests like the STAAR or MAP tests. By utilizing this educational data 146, the collector 120 ensures that the educational data 146 is collected in a standardized format, which facilitates further processing, normalization, and analysis.

This approach also allows for scalability and flexibility. As new educational platforms and tools emerge, their APIs can be integrated into the mastery level determining system 100, ensuring the data collection remains robust and up-to-date.

In operation 204, a normalization module 122 normalizes the collected one or more educational data 146 by defining each educational data 146 based on the standards of an educational curriculum. The normalization module 122 is integrated within the user educational data centralization module 118. The normalization module 122 receives the collected educational data from the collector 120.

The collected user educational data 146 is ingested into a performance matrix to maintain uniformity across the educational curriculums 148 and the online learning platforms 102. The educational data collection and normalization are discussed in detail in the application No. 63/652,140 and the concurrently filed U.S. patent application having Attorney Docket No. T00655GT, entitled “SYSTEM AND METHOD FOR GENERATING STANDARDIZED PERFORMANCE METRICS FOR A USER BASED ON EDUCATION DATA RECEIVED FROM ONE OR MORE EDUCATION PLATFORMS, which are both hereby incorporated by reference in their entireties.

Standardizing and normalizing the collected user educational data 146 are essential processes that ensure data from the various educational platforms 106 can be integrated, analyzed, and utilized consistently. The educational data 146 is collected from external educational sources 106, such as online quizzes 108, external assessments 110, and online learning apps. Each educational platform 106 may provide the educational data 146 in different formats, demanding a comprehensive data collection approach. This involves utilizing the API 116 to collect the educational data 146 effectively.

Next, the collected educational data 146 undergoes standardization to transform it into a predefined format that maintains uniformity. This step involves reformatting the educational data 146 to adhere to a common structure or model, ensuring consistency across all data points. The fields from the different educational platforms 106 are then mapped to corresponding fields in a common mastery structure. This mapping aligns various data points, such as scores, completion statuses, and timestamps, with standardized fields, facilitating seamless integration and interpretation of the educational data 146. Once standardized, the educational data 146 is stored for further processing and analysis.

Following standardization, the educational data 146 is normalized to align with predefined educational standards, such as Common Core, NGSS, and AP using the normalization module 122. The normalization module 122 is integrated within the user educational data centralization module 118. This step begins by identifying relevant educational standards and converting the standardized data into a format that aligns with these standards. The normalization involves adjusting the data according to the difficulty levels, scopes, and contexts of the educational standards using the normalization module 122. The normalized data is then stored in a centralized cloud database 114, consolidating information from various sources into a unified framework.

The normalization module 122 includes a machine learning module 124 integrated within that identifies patterns and relationships between educational data 146 from different platforms 106 and the educational standards. This machine learning module 124 employs advanced algorithms to continuously refine and improve the mapping accuracy, ensuring that the collected educational data aligns seamlessly with established standards such as Common Core, NGSS, and AP. By doing so, the user educational data centralization module 118 not only maintains the integrity and uniformity of the educational data 146 but also adapts over time, learning from new data inputs to enhance its performance.

In operation 206, an evaluator 142 evaluates the most recent and reliable user educational data 146 by determining the current mastery state for each skill by prioritizing more recent and reliable data over older and less reliable data.

The evaluator 142 utilizes NLP (Natural Language Processing) techniques to analyze the normalized data based on textual inputs, such as user queries or responses, in a natural and meaningful way. The evaluator 142 process and interpret textual data from various sources, such as educational assessments or user interactions. The evaluator 142 can understand the semantics and context of these inputs, thereby extracting key information. For instance, if a user submits a question or provides an answer regarding their mastery of a specific skill, the evaluator 142 uses NLP to distinguish the intent and context of the input, subsequently assess the user's current mastery state for that skill.

Meanwhile, a mastery level determination system 132 is responsible for processing and evaluating the educational data 146 provided. The mastery level determination system 132 integrates various algorithms and logic, often including machine learning algorithms, to analyze the collected user educational data 146. This analysis focuses on determining the current mastery state for each skill, prioritizing more recent and reliable data over older or less reliable information.

The evaluator 142 within the mastery level determination system 132 applies predefined criteria or algorithms to the standardized and normalized educational data to assess the user's proficiency accurately. The evaluator 142 considers factors such as the source reliability, timestamp of the data, and potentially the performance context e.g., assessment type or difficulty level. By systematically evaluating these factors, the evaluator 142 ensures that the assessments reflect the user's current knowledge level as closely as possible.

In operation 208, a reliability score calculator 136 and a recency score calculator 138 calculates and assigns a reliability score and recency score. The calculated reliability score and recency score are assigned to each normalized educational data based on the trustworthiness, and timestamps of each educational data 146 respectively.

The reliability score calculator 136 and the recency score calculator 138 assesses and categorizes the user's mastery levels based on collected educational data 146 from the various educational platforms 106. The reliability score calculator 136 and the recency score calculator 138 utilize Natural Language Processing (NLP) techniques to enhance their functionality. The reliability score calculator 136 evaluates the trustworthiness of each educational data 146, considering factors such as source credibility and data quality, utilizing NLP techniques to analyze textual information for reliability indicators.

Simultaneously, the recency score calculator 138 determines the freshness of each educational data 146 by analyzing timestamps. The recency score calculator 138 employs machine learning algorithms to prioritize more recent educational data 146, ensuring that the user's current mastery status is reflected accurately. For instance, recent achievements or assessments hold more weight in determining the user's proficiency compared to older data.

Furthermore, the evaluation and assignment involve several steps to refine the accuracy of mastery assessments. It begins with receiving timestamped educational data 146 from the various educational platforms 106 like the online learning tools 112, quizzes 108, and external assessments 110. Machine learning algorithms are then utilized to compute recency scores, comparing timestamps to ascertain the latest assessments. Additionally, relevancy scores are assigned based on how well each data entry aligns with predefined educational standards and criteria. These scores are adjusted using weighting factors to emphasize the impact of recency and relevancy in categorizing the user's mastery state, which is then categorized into simplified states like unknown, learning, learned, or confirmed.

For example, if a student completes a quiz on a learning app, the mastery level determination system 132 utilizes the reliability score calculator 136 and the recency score calculator 138 to evaluate the recency and relevancy of the quiz results. Recent quiz attempts are given higher recency scores, indicating their relevance to the current assessment of the student's proficiency level. Similarly, if the quiz questions are aligned with specific educational standards such as Common Core, NGSS, AP, and so on, the relevancy score ensures that this data contributes directly to assessing the student's mastery of those standards.

In operation 210, a categorization module 140 categorizes the user's mastery skills obtained from the normalized educational data to provide a clear representation of the user's knowledge level. The categories in which the normalized educational data is divided include unknown, learning, learned, and confirmed.

The categorization module 140 updates and maintains the accuracy of a user's mastery levels in real-time as new educational data is collected and processed. The categorization module 140 is integrated into the mastery level determination system 132. The categorization module 140 systematically categorizes the user's mastery skills derived from the normalized educational data. The categorization module 140 ensures a clear and concise representation of the user's knowledge level by dividing the data into four distinct categories: unknown, learning, learned, and confirmed.

The ‘unknown’ category indicates that the user educational data centralization module 118 lacks any data on the user's mastery of a particular educational standard. ‘Learning’ suggests that the user has started making progress but has not yet fully mastered the skill. ‘Learned’ means that the user has demonstrated mastery in a learning app 112 or through internal tests 108. Finally, ‘confirmed’ reflects that the user's knowledge has been validated through external testing 110.

The user educational data centralization module 118 triangulates data from three distinct sources: internal quizzes 108, external tests 110, and online learning apps. Instead of relying on a complex state machine, it utilizes the chronological order and inherent reliability of these tri-state signals (learned, not learned, no data) to infer mastery. This provides a straightforward and reliable way to keep the user's mastery levels current and updated, offering educators and users a clear view of the learning progress and areas needing further attention.

The codes and functions mentioned in the pseudo-code of the mastery level determining system 100 from the centralized mastery structure generated from external educational sources 106 for data triangulation are explained below in correspondence to the above mentioned details.

The Data Source Signal Triangulation function, ‘(triangulate_data_sources (app_mastery, quiz_results, external_test_results)’, combines data from multiple sources to determine the most accurate state of mastery for a skill. It first creates a list of data sources, including learning apps 112, quizzes 108, and external tests 110, and then filters out sources with no data. It uses weighting factors for recency and reliability (both set to 0.5) to sort the valid sources. The function returns the most reliable and recent source of mastery data, if available. This triangulation process helps ensure that the mastery level determining system 100 bases its assessment on the best available data. The function for Skill State Abstraction with Tags, ‘(abstract_skill_state_and_tags (triangulated_source, external_test_results)’, simplifies the skill state into a more general mastery state and assigns relevant tags based on the reliability and recency of the data source. If a reliable source of mastery data is available, it determines the mastery state (Unknown, Learning, Learned, Confirmed) by evaluating the data and checking for recent external_test_results. Additionally, it assigns tags for high or low reliability and whether the data was recently updated or potentially outdated. This abstraction provides a clear and concise summary of the skill state.

Further, the Unified Skill Stack function, ‘(unified_skill_stack (student_id, learning_apps, quizzes, external_tests, skill_dependencies, all_skills)’, integrates information from various sources to build a comprehensive knowledge graph for each student. It initializes the student's knowledge graph and processes each skill along with its dependencies. For each skill, it retrieves mastery data from learning apps, quizzes, and external tests, and then triangulates this data to find the most reliable source. The function abstracts the mastery state and associated tags and updates the knowledge graph accordingly. If any skills have unknown mastery states, it predicts these states based on the known states of their dependencies. Finally, it updates the global knowledge graph with the processed data for the user.

In operation 212, the user receives simplified mastery states and associated descriptive tags via. the API 116 to the online learning platform 102 for further use in personalized learning experiences and user assessments.

The mastery structure is a framework that organizes and represents a user's mastery data uniformly across the various educational platforms 106. This structure ensures consistency and standardization of learning progress, regardless of the data source. The user's mastery states are displayed on an integrated user interface 104 within the online learning platform 102, presented in a simplified format with descriptive tags for additional context. The API 116 facilitates the delivery of this structured data, allowing users to use the information for personalized learning experiences and assessments.

The codes and functions mentioned in the pseudo-code of the mastery level determining system 100 from the centralized mastery structure generated from external educational sources 106 to update the knowledge graph are explained below in correspondence to the above mentioned details.

Finally, the Update Global Knowledge Graph function, ‘(update_global_knowledge_graph (student_id, knowledge_graph)’, updates the overall knowledge graph for the user. This function would replace the current knowledge graph with the updated one, ensuring that the mastery level determining system 100 maintains an accurate and up-to-date record of each user's skill mastery. The example use case demonstrates how the mastery level determining system 100 functions by calling ‘unified_skill_stack’ with a sample student ID and appropriately filled data structures for learning apps, quizzes, external tests, and skill_dependencies to build a student's knowledge graph.

The Mastery and Skill Dependency Graph function, ‘(predict_mastery_based_on_dependencies (skill_id, knowledge_graph, skill_dependencies)’, infers the mastery state of a skill based on the states of its dependencies. It identifies skills that depend on the given skill and checks if all dependent skills are either Learned or Confirmed. It also evaluates the dependencies of the skill itself to see if they are all in a Learning state. These evaluations update the predicted mastery state of the skill. This function helps to fill in gaps in the knowledge_graph where direct mastery data might be missing.

The mastery level determining system 100 from the centralized mastery structure generated from external educational sources 106 further comprises a feedback module 130 integrated within the user educational data centralization module 118. The feedback module 130 is operatively connected to the user interface 104 of the online learning platform 102. The feedback module 130 automatically generates real-time feedback based on the assessed mastery states of the user. The feedback module 130 analyzes the current mastery level of each skill, as determined by the evaluation of educational data 146 from various educational platforms 106. Upon identifying the user's proficiency in different areas, feedback module 130 provides targeted recommendations that are in correspondence with the individual's needs. These recommendations can include suggestions for further learning activities to address gaps in knowledge, specific practice exercises to reinforce recently acquired skills, or additional assessments to confirm mastery of certain topics. By delivering these personalized recommendations promptly, the feedback module 130 helps guide the user towards a more effective and efficient learning path, ensuring that their educational experience is continuously optimized to meet their evolving needs and goals. This real-time feedback mechanism not only supports the user in their learning journey but also enables educators to make informed decisions about instructional strategies and interventions.

The pseudo-code for the mastery level determining system 100 from the centralized mastery structure generated from the external educational sources 106 is given below:

```
  # Pseudo-code for Unified Educational Knowledge Graph System
  # Global constants and threshold values − should be set based on
system requirements
  RECENT_ACTIVITY_THRESHOLD_DAYS = 90
  SOURCE_RELIABILITY_SCORES = {
          # Note that these can also be configured based on the
specific reliability of each data source, e.g. individual learning apps
or tests
          ‘learning_app’: 0.7, # Learning app reliability
          ‘internal_test’: 0.9, # Quiz reliability
          ‘external_test’: 0.8 # External test reliability
  }
    # Helper functions to process individual sources of mastery
information
  def get_mastery_data_from_apps(skill_id, learning_apps):
          # Retrieve and return mastery data from learning apps for
the given skill_id
          pass
    def get_mastery_data_from_quizzes(skill_id, internal_tests):
          # Retrieve and return mastery data from internal_tests for
the given skill_id
          pass
    def get_mastery_data_from_external_tests(skill_id,
external_tests):
          # Retrieve and return mastery data from external tests for
the given skill_id
          pass
  # Novelty 3: Data Source Signal Triangulation for Skill Mastery
  def triangulate_data_sources(app_mastery, quiz_results,
external_test_results):
          “““
          Combines signals from various data sources to infer the
most accurate state of mastery for a skill.
          Considers the recency and reliability of data from learning
apps, quizzes, and external tests.
          ”””
          # List of data sources for triangulation
          sources = [
          {‘type’: ‘learning_app’, ‘mastery’: app_mastery},
          {‘type’: ‘internal_test’, ‘mastery’: quiz_results},
          {‘type’: ‘external_test’, ‘mastery’: external_test_results}
          ]
          # Filter out sources with no data
          valid_sources = [source for source in sources if
source[‘mastery’] is not None]
          # Define weighting factors for recency and reliability
          RECENCY_WEIGHT = 0.5
          RELIABILITY_WEIGHT = 0.5
          # Sort by a weighted combination of recency and reliability
          sorted_sources = sorted(valid_sources, key=lambda x: (
            −RECENCY_WEIGHT * ((current_datetime −
x[‘mastery’] [‘timestamp’]).days / 7. 0) +
            RELIABILITY_WEIGHT * SOURCE_RELIABILITY_SCORES[x[‘type’]]
          ), reverse=True)
    # Return the most recent and reliable source of mastery data
          return sorted_sources[0] if sorted_sources else None
    # Novelty 2: Skill State Abstraction with Tags
  def abstract_skill_state_and_tags(triangulated_source,
external_test_results):
          “““
          Abstracts the skill state into a simplified mastery state
with tags based on data source
          reliability and recency.
          ”””
          if triangulated_source:
          source_type, mastery_data = triangulated_source[‘type’],
triangulated_source[‘mastery’]
            reliability_score =
SOURCE_RELIABILITY_SCORES[source_type]
          recency_score = (current_datetime −
mastery_data[‘timestamp’]).days
          tags = [ ]
          # Determine mastery state
          # Determine mastery state based on the data source and
mastery data
          if mastery_data[‘mastery_state’] == ‘none’:
              mastery_state = ‘Unknown’
          elif mastery_data[‘mastery_state’] == ‘not mastered’:
              mastery_state = ‘Learning’
          elif mastery_data[‘mastery_state’] == ‘mastered’:
              if source_type in [‘learning_app’, ‘internal_test’]:
                  # Check the most recent external test result
                recent_external_test = max(external_test_results,
key=lambda x: x[‘timestamp’], default=None)
                  if recent_external_test and
recent_external_test[‘mastery_state’] == ‘mastered’:
                    mastery_state = ‘Confirmed’
                  else:
                    mastery_state = ‘Learned’
              elif source_type == ‘external_test’:
                mastery_state = ‘Confirmed’
          # Implementation for arbitrary tags that provide additional
context for consumers. Some examples below
          # Tag for reliability
          if reliability_score > 0.7:
              tags.append(‘high_reliability’)
          else:
              tags.append(‘low_reliability’)
          # Tag for recency
          if recency_score <= RECENT_ACTIVITY_THRESHOLD_DAYS:
              tags.append(‘recently_updated’)
          else:
              tags.append(‘potentially_outdated’)
          return mastery_state, tags
          else:
          # No data available for triangulation
          return “unknown”, [‘no_data_available’]
    # Novelty 1: Unified Skill Stack
  def unified_skill_stack(student_id, learning_apps, quizzes,
external_tests, skill_dependencies, all_skills):
          “““
          This function aggregates the information provided by lower-
level functions to build and maintain
          a comprehensive knowledge graph for each student.
          ”””
          # Initialize student's knowledge graph
          knowledge_graph = { }
  # Iterate through each skill and its dependencies
          for skill_id, dependencies in all_skills:
          app_mastery = get_mastery_data_from_apps(skill_id,
learning_apps)
          quiz_results = get_mastery_data_from_quizzes(skill_id,
quizzes)
            external_test_results =
get_mastery_data_from_external_tests(skill_id, external_tests)
          # Triangulate signals from all data sources
            most_reliable_source =
triangulate_data_sources(app_mastery, quiz_results,
external_test_results)
          # Abstract mastery state and associated tags
          mastery_state, tags =
abstract_skill_state_and_tags(most_reliable_source,
external_test_results)
          # Update knowledge graph for the student with the processed
data
            knowledge_graph[skill_id] = {
              ‘mastery_state’: mastery_state,
              ‘tags': tags
          }
          # Check and update unknown mastery states using dependency
predictions
          for skill_id, skill_data in knowledge_graph.items( ):
          if skill_data[‘mastery_state’] == ‘unknown’:
              predicted_state =
predict_mastery_based_on_dependencies(skill_id, knowledge_graph,
skill_dependencies)
              knowledge_graph[skill_id] [‘mastery_state’] =
predicted_state
    # Update global knowledge graph
        update_global_knowledge_graph(student_id, knowledge_graph)
    # Novelty 4: Mastery and Skill Dependency Graph
  def predict_mastery_based_on_dependencies(skill_id,
knowledge_graph, skill_dependencies):
          “““
          Infers the mastery state of a skill based on the known
states of its dependencies.
          ”””
          # Find skills that depend on this skill_id
          dependent_skills = [s for s, deps in
skill_dependencies.items( ) if skill_id in deps]
    # Check if all skills depending on this standard are either
“Learned” or “Confirmed”
          if all(knowledge_graph[skill] [‘mastery_state’] in
[‘Learned’, ‘Confirmed’] for skill in dependent_skills):
            predicted_mastery = ‘Learned’
    # Find dependencies for the skill
          dependencies = skill_dependencies.get(skill_id, [ ])
      # If no dependencies, return current known state
          if not dependencies:
          return knowledge_graph[skill_id] [‘mastery_state’]
    # Check if all of the skill's dependencies are “Learning”
          if all(knowledge_graph[dependency] [‘mastery_state’] ==
‘Learning’ for dependency in dependencies):
            predicted_mastery = ‘Learning’
        knowledge_graph[skill_id] [‘predicted_mastery_state’] =
predicted_mastery
  return knowledge_graph[skill_id] [‘predicted_mastery_state’]
    # Placeholder update function for the global knowledge graph
  def update_global_knowledge_graph(student_id, knowledge_graph):
          # This function should replace the current knowledge graph
for the student with the updated one.
          pass
    # Example use of the system
  student_id = ‘example_student’
  # Assume appropriately filled data structures for learning_apps,
quizzes, external_tests, and skill_dependencies
  unified_skill_stack(student_id, learning_apps, quizzes,
external_tests, skill_dependencies, all_skills)
```

In another embodiment, the mastery level determining system 100 from the centralized mastery structure generated from the external educational sources 106 utilizes the mastery level determination system 132 to infer mastery states for skills lacking availability of the direct educational data, thereby utilizing known mastery data of interdependent skills, and predicting the user's knowledge level based on the relationships between different skills using a predictor 144.

The knowledge graph employed by the mastery level determination system 132 deduces the mastery states of skills even when the direct educational data 146 is not known. By integrating known mastery data from related skills within the knowledge graph, the mastery level determination system 132 can infer the user's proficiency levels across different educational standards using the predictor 144, integrated within the mastery level determination system 132. The mastery level determining process 200 from the centralized mastery structure generated from the external educational sources 106 provides a broad view of the user's educational journey, facilitating personalized learning pathways that are in correspondence with the user's specific skill dependencies and mastery patterns.

The predictor 144 analyzes the interconnectedness of skills within the knowledge graph and forecasts how the user's proficiency in one skill might influence their mastery of related skills. By employing machine learning algorithms and statistical models, the predictor 144 enhances the ability to anticipate the user's knowledge level dynamically. This predictive functionality enables educators and learners to receive timely and accurate insights, providing continuous improvement in educational outcomes through targeted support and guidance.

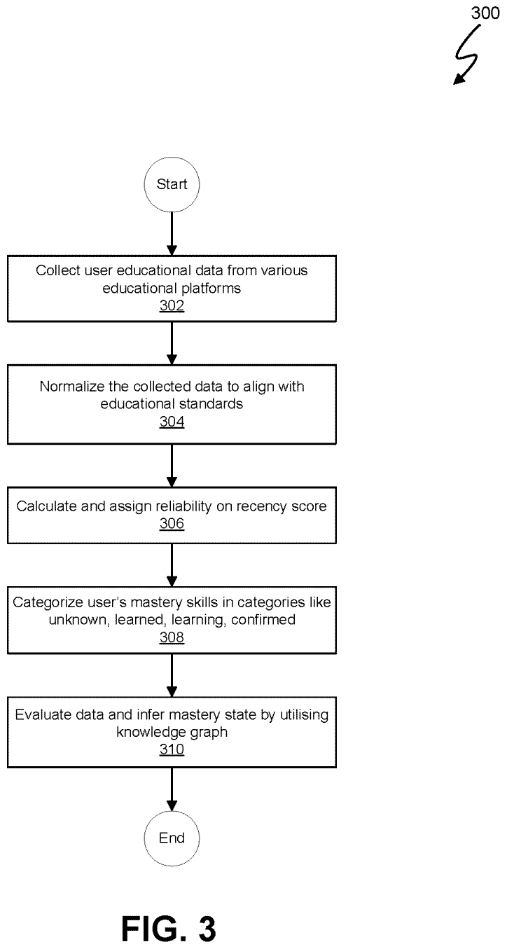

FIG. 3 depicts a user mastery level establishing process 300 from the centralized mastery structure generated from educational data 146 collected from external educational sources 106, which is an embodiment of the mastery level determining process 200 from the centralized mastery structure generated from the external educational sources 106 of FIG. 2.

The user mastery level establishing process 300 illustrates a detailed process for assessing and updating a user's mastery levels in various educational subjects using the educational data 146 from the various educational platforms 106. The user mastery level establishing process 300 begins with collection 302 of the user educational data 146 from the various educational platforms 106, including the internal school tests 108, the external assessments 110, and the online learning applications 112. For example, Peter, a high school student studying physics, has his educational data 146 gathered from his physics learning app, school quizzes, and results from a national physics competition.

Next, the collected data is normalized 304 to align with the educational standards using the normalization module 122, transforming it into a structured format consistent with standards such as the Common Core or Next Generation Science Standards NGSS. This ensures that data from the different educational platforms 106 is comparable and consistent. Following normalization, the mastery level determination system 132 evaluates the most relevant and recent data. The evaluator 142 (not shown in the figure) the evaluates the data for calculating the reliability and recency score 306. The reliability and recency score is calculated using the reliability score calculator 136 and the recency score calculator 138 (not shown in the figure) and assigns them based on the normalized educational data 146. For instance, recent high scores from a reputable physics competition might receive high reliability and recency scores due to the source's credibility and the freshness of the data.

Subsequently, the user's mastery skills are categorized 308 into categories such as unknown, learning, learned, and confirmed using the categorization module 140. For example, if Peter shows consistently high scores in his learning app but lower performance in recent school quizzes, his skill in ‘Electromagnetism’ might be categorized as ‘learning’ rather than ‘learned.’

This mastery level determination system 132 evaluates the data and infers the mastery state by utilizing a knowledge graph 310. The knowledge graph helps in understanding the relationships between different skills and predicting mastery levels even for skills without direct data. For instance, if Peter has mastered ‘Basic Circuit Theory,’ the Mastery level determination system 132 might infer that he has a good grasp of ‘Ohm's Law’ as well.

Finally, the user mastery level establishing process 300 ends with the Mastery level determination system 132 providing an overview of the user's mastery states, allowing educators to tailor future learning activities and assessments to the student's current needs. This structured approach ensures that Peter's learning journey in physics is continuously monitored and updated based on the most accurate and recent information available.

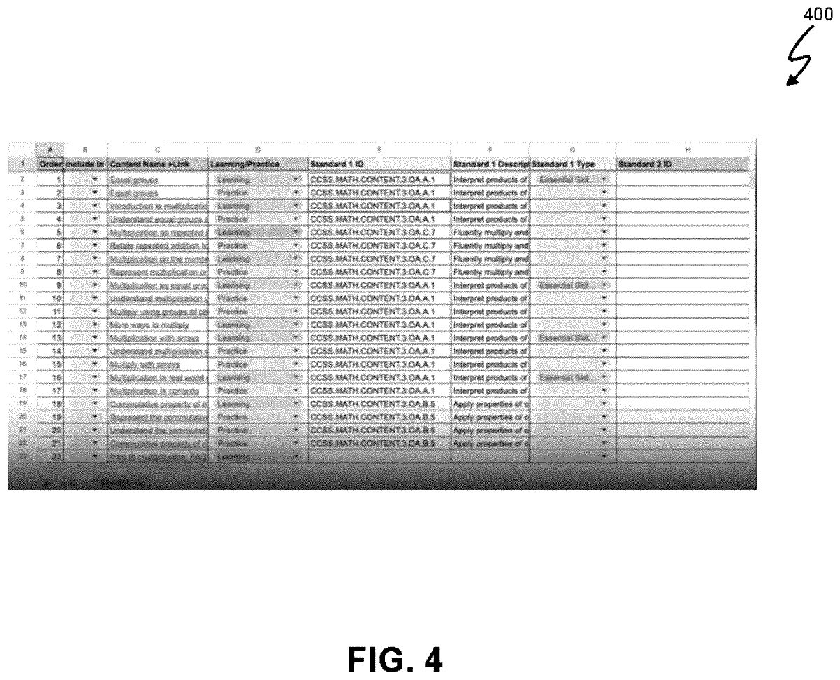

FIG. 4 depicts spreadsheet 400 in which the details related to the educational curriculum 148 are disclosed in tabular format.

The spreadsheet 400 provided organizes educational activities centered around multiplication skills according to the Common Core State Standards (CCSS) for Grade 3 mathematics. Each entry in the sheet represents either a learning or practice activity designed to reinforce specific concepts related to multiplication. For instance, activities focus on interpreting products of whole numbers through scenarios like equal groups, arrays, and real-world contexts. They also aim to develop fluency in multiplication and division within 100, emphasizing strategies such as repeated addition and understanding the relationships between operations.

Furthermore, the spreadsheet 400 includes exercises that illustrate properties of operations, including the commutative property of multiplication and the distributive property, ensuring students grasp fundamental mathematical principles. By aligning activities with clear CCSS standards and providing detailed descriptions of learning objectives, the spreadsheet 400 provides structured learning experiences that support students in mastering essential multiplication skills necessary for further mathematical proficiency. CCSS is taken here just for explanation, other educational standards can also be used like NGSS (Next Generation Science Standards), AP (Advanced Placements), and so on.

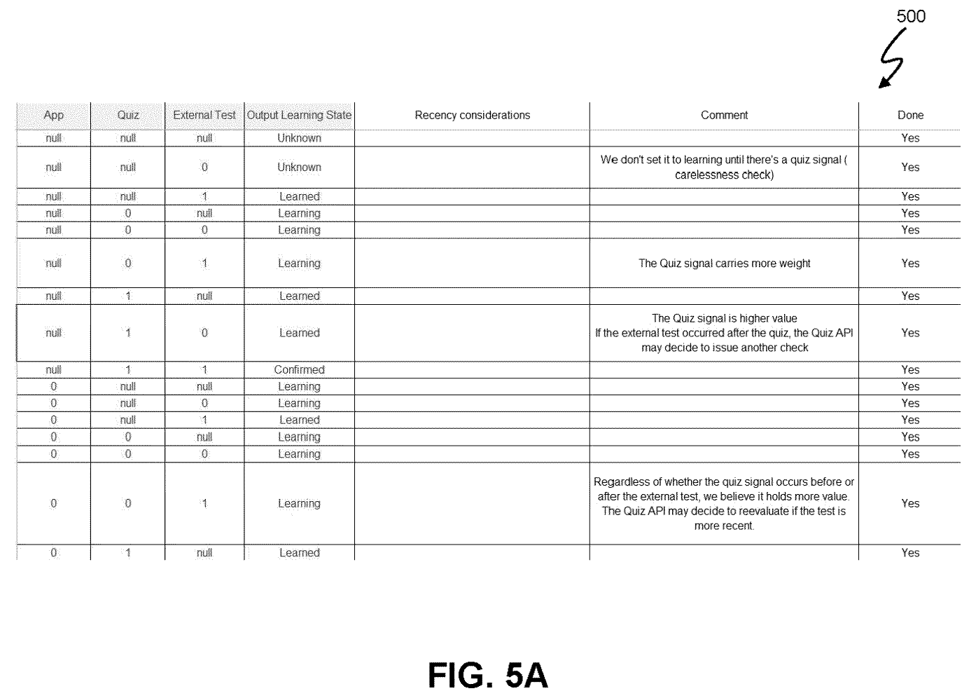

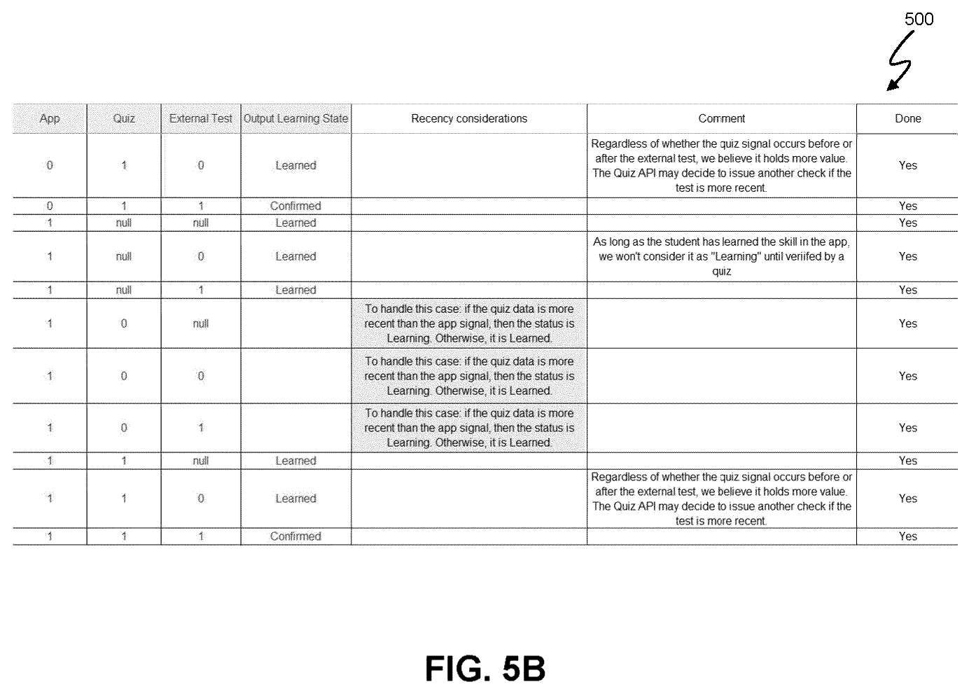

FIGS. 5a and 5b depict a spreadsheet 500 in which a truth table discloses the mastery level of the user.

The spreadsheet 500 provided details on a structured method for assessing and categorizing a student's learning progress based on inputs from the online learning app 112, the quiz 108, and the external tests 110. Each row represents a unique scenario where the presence or absence of the educational data 146 from these sources influences the determination of the student's learning state. The ‘Output Learning State’ column reflects the result of this assessment, ranging from ‘Unknown’ when no data is available to ‘Learned’ or ‘Confirmed’ when sufficient evidence from quizzes and external tests supports the student's mastery of a skill.

The spreadsheet 500 incorporates considerations of data recency in the ‘Recency considerations’ column, which affects the decision-making process. Comments provided in the spreadsheet explain specific rules and conditions under which each learning state is assigned. For instance, it clarifies that a quiz signal holds significant weight in determining the ‘Learning’ or ‘Learned’ states and an external test confirmation elevates the status to ‘Confirmed.’

In the spreadsheet analysis, each row represents a specific scenario dictating the student's learning state based on available data from the app, quizzes, and external tests. In Row 1, where there is no data from any source (App, Quiz, or External Test), the student's state is marked as ‘Unknown.’ This decision considers recency as indicated (‘Yes’), emphasizing the need for updated information to determine proficiency. Moving to Row 3, a quiz result is available alongside an external test signal (External Test=1), resulting in a determination of ‘Learned.’ Recency considerations continue to be relevant (‘Yes’), ensuring recent assessments hold more weight in evaluating the student's understanding.

Row 5 shows a scenario where a quiz result is available (Quiz=0), suggesting the student is currently in the learning process (‘Learning’). Recency considerations are again noted (‘Yes’), underscoring the ongoing nature of skill acquisition.

In Row 9, despite having app data (App=0) indicating learning, the absence of quiz or external test data maintains the state as ‘Learning.’ Recency considerations remain applicable (‘Yes’), highlighting the importance of comprehensive assessment data.

Row 13 reflects a situation where both app and quiz data are available, but external test data is missing. The student is classified as ‘Learning,’ with recency considerations guiding the assessment (‘Yes’), ensuring a balanced evaluation of the student's progress.

Moving forward to Row 17, where app data confirms learning (App=1), validated by a quiz result. The state is set to ‘Learning,’ with recency considerations applied (‘Yes’), emphasizing the role of recent assessments in determining the student's current skill level.

Finally, in Row 21, all data points align (App=1, Quiz=0, External Test=1), resulting in a confirmed state of ‘Confirmed.’ This comprehensive validation indicates the student has mastered the skill, with recency considerations reinforcing the reliability of recent assessment outcomes (‘Yes’).

Overall, these rows illustrate a systematic approach to assessing and categorizing student learning states based on varying combinations of app, quiz, and external test data, while emphasizing the importance of recency in determining proficiency levels.

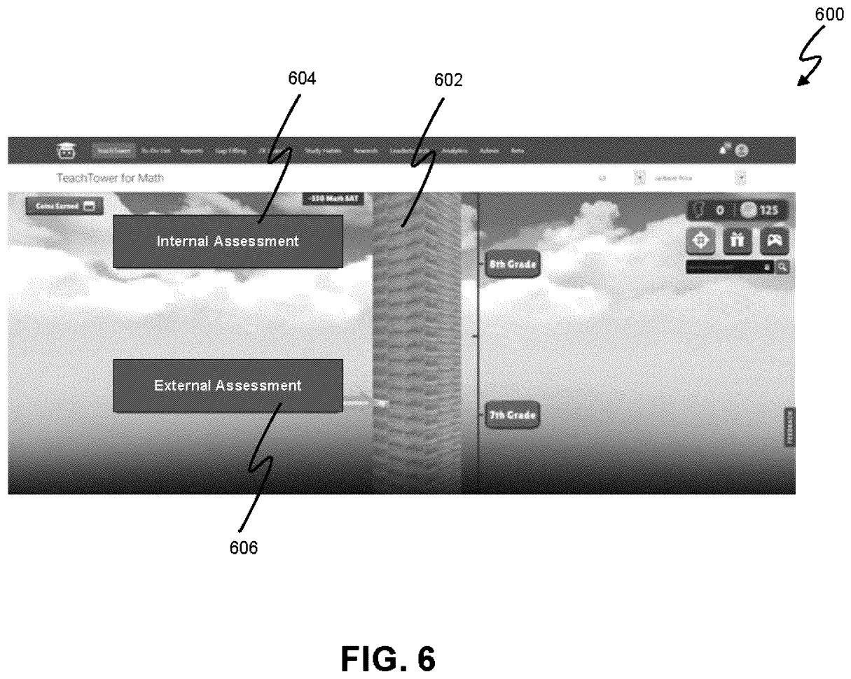

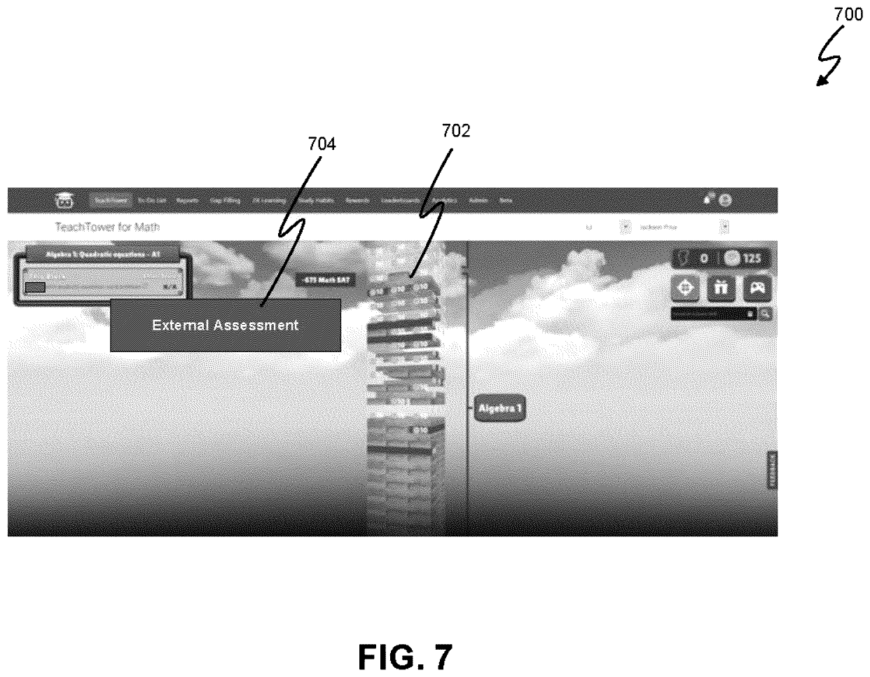

FIGS. 6 and 7 depict exemplary user interfaces 600 and 700 showing the knowledge level attained by a user through the mastery structure of a user.

The user interface 600 illustrates a mastery structure 602 of the users using the online learning platform 102. The mastery structure 602 shows the mastery status of the user obtained from an internal assessment tests 604, and an external assessments 606. The internal assessment tests may include school tests, coaching tests, home-based tests, and so on, whereas the external assessments 606 include assessments like SAT, STAAR, GRE, TOEFL, and so on using which the user can check his/her mastery level. The internal assessment test 604 details of the 7th grade, and the external assessment test 606 details of the 8th grade are displayed in the user interface 600.

The user interface 700 discloses the mastery structure 702 which provides the details of external assessment 704 of the user based on which the educational content is provided to the user for learning. For instance, in the exemplary scenario, the user has achieved 61% mastery in an external assessment 704 in Algebra. The user can click on the mastery structure 702 to get the relevant educational content, which is made available to the user on the left corner of the user interface 700. In this example, the educational content related to the Quadratic Equations is provided to the user, since the user has to work on this area to improvise the mastery level

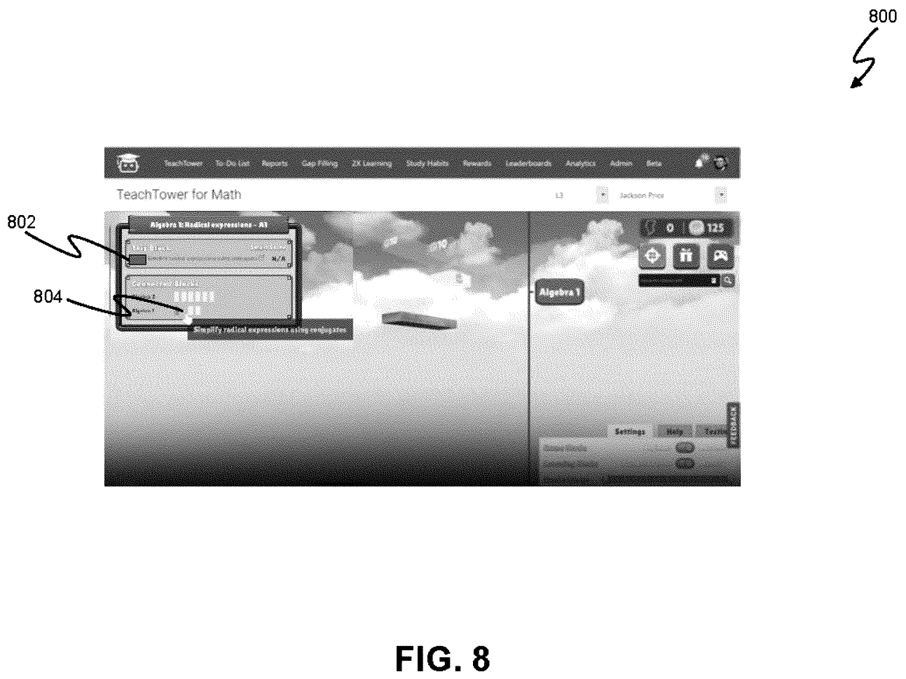

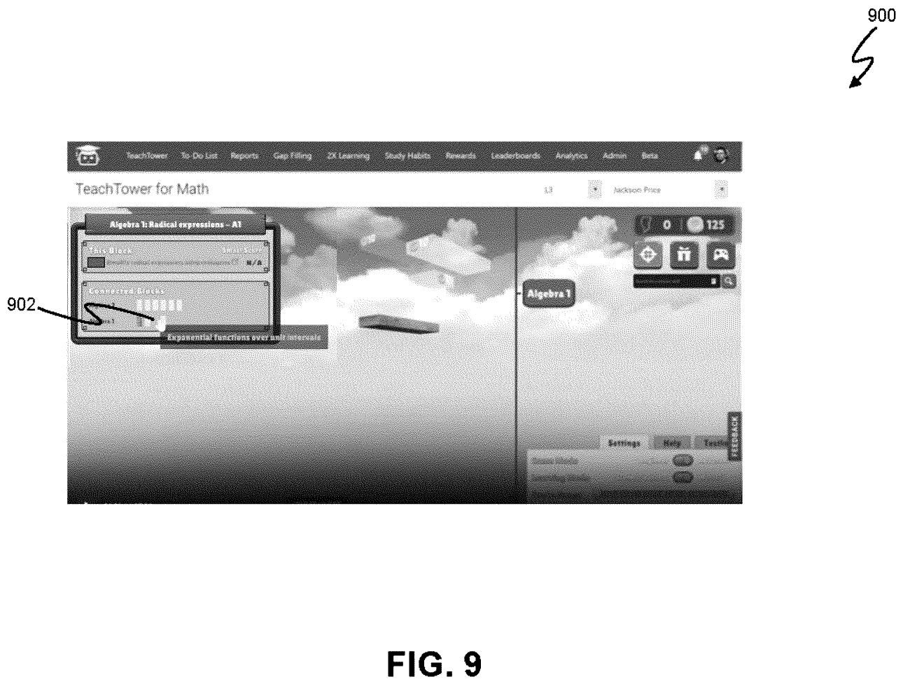

FIGS. 8 and 9 depict an exemplary user interface 800 showing the dependencies within the educational standards.

The user interface 800 shows the interdependencies within the educational standard. As mentioned above in FIG. 7 the user is learning Algebra. On the selection of a particular topic, say, ‘Simplify radical expression using conjugates’ 802, the topics and sub-topics that are dependent on this topic 804 will appear on block 902. The user can select the topic of his/her choice to attain learning, for instance, the user has selected simplify radical expression using conjugates (as given in FIG. 8), and exponential function over unit interval (as given in FIG. 9).

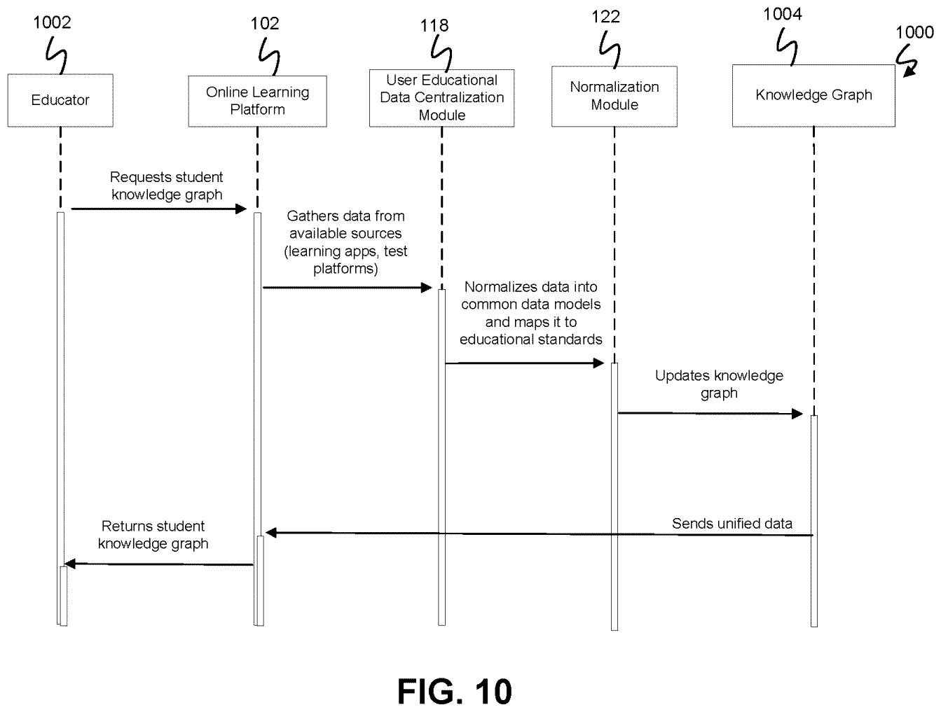

FIG. 10 depicts a mastery structure upgradation process 1000 using the users' educational data 146 from the different education platforms 106, which is an embodiment of the mastery level determining process 200 from the centralized mastery structure generated from the external educational sources 106 of FIG. 2.

The mastery structure upgradation process 1000 from the centralized mastery structure generated from the educational data collected 146 from the external educational sources 106 is designed to centralize and standardize a student's knowledge graph 1004 by integrating and processing the educational data 146 from the various educational platforms 106.

The mastery structure upgradation process 1000 begins when an educator 1002 interacts with the online learning platform 102, requesting the student's knowledge graph 1004. This request sets off a series of operations namely, collecting the user's educational data 146 from various educational platforms 106, normalizing the collected educational data 146 in a simple and pre-defined format, and mapping the student's mastery data from the various educational platforms, including learning apps 112, quizzes 108 (may also be referred to as ‘internal tests’, ‘assessments’), and external tests 110 to categorize the collected educational data 146 into different categories namely, unknown, learning, learned, and confirmed.

Upon receiving the educator's request, the online learning platform 102 communicates with the user educational data centralization module 118 to gather the necessary educational data 146 from the available educational platforms 106. These educational sources 106 might include results from internal school-based assessments 108, scores from standardized external tests 110, and different learning applications 112 that the student uses. Each educational platform 106 typically uses its unique format and metrics to represent the student's mastery level and educational data 146.

The collected data is then sent to the normalization module 122, which converts the different data formats into a mastery structure with a common format. The normalization part ensures that all incoming data is uniform and compatible, regardless of the source of the educational data 146. This standardization allows for consistent interpretation and analysis across different educational platforms 106 and standards. The normalized data is then mapped to specific educational standards, such as the Common Core State Standards (CCSS), NGSS (Next Generation Science Standards), and so on ensuring that the student's progress is evaluated against a consistent set of criteria.

After the data is normalized and mapped, it updates the student's knowledge graph 1004. The knowledge graph 1004 is a centralized repository that provides a structured overview of the student's mastery levels across various skills. The knowledge graph 1004 represents the students' knowledge in a clear and organized manner, making it easy for educators 1002 to see the student's strengths and areas that need improvement.

Once the knowledge graph 1004 is updated, the online learning platform 102 retrieves this incorporated data. The knowledge graph 1004 now presents a consolidated view of the student's mastery, integrating information from all the educational platforms 106. This unified data is then returned to the educator 1002 via. the online learning platform 102. The final output is a detailed and standardized overview of the student's progress, which the educator 1002 can use to make informed decisions about the student's learning path and necessary interventions.

For instance, an educator 1002 tries to understand a student's Math progress from the various educational apps 106 and assessments. Each source uses different formats and metrics, making it hard to get a clear picture. The knowledge graph 1004 solves this by automatically gathering and standardizing data from all sources into a unified format. It then maps this data to educational standards like the Common Core, providing a centralized view of the student's strengths and areas needing improvement. This helps the teacher make informed decisions about the student's learning path more effectively.

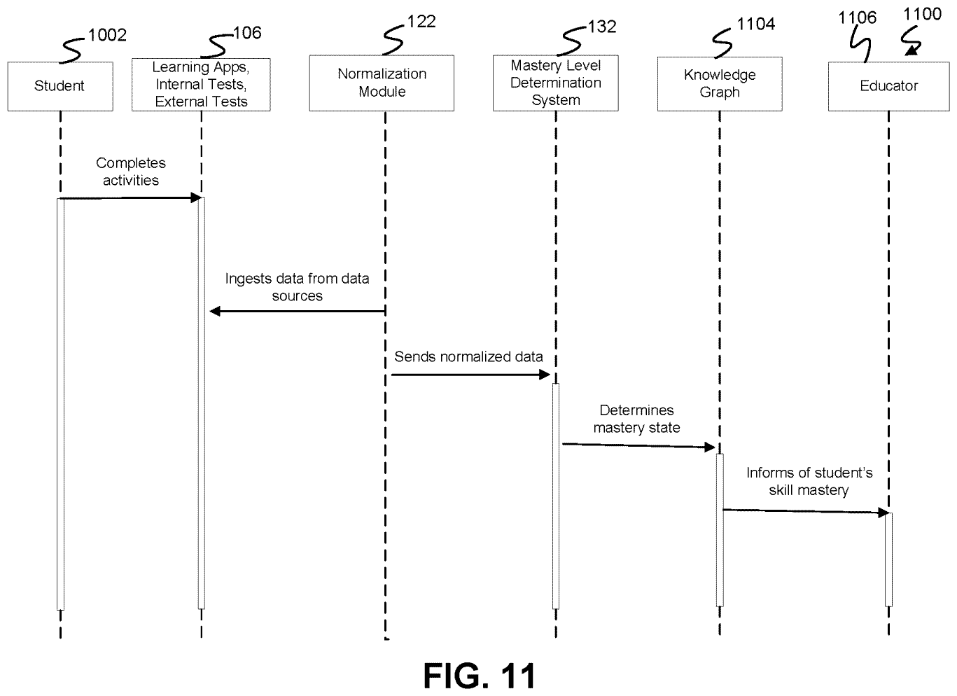

FIG. 11 depicts a student's 1102 mastery level communication process 1100, which is an embodiment of the mastery level determining process 200 from the centralized mastery structure generated from the external educational sources 106 of FIG. 2.

The student's 1102 mastery level communication process 1100 illustrates how the centralized mastery structure generated from the educational data collected 146 from the external educational sources 106 processes the internal assessments 108, the external tests 110, and the educational data 146 from various learning apps to determine and communicate the student's skill mastery state to an educator.

Firstly, student 1102 completes the internal school tests 108, takes the external standardized tests 110, and interacts with the learning apps 112. These activities generate mastery data for specific skills aligned with educational standards like the Common Core State Standards (CCSS). The data from the educational platforms 106 is then ingested and normalized by the normalization module 122, ensuring consistency and compatibility across different formats and educational standards. This normalization step prepares the data for further processing.

Next, the mastery level determination system 132 process the normalized data to determine the student's mastery state for each skill. The mastery level determination system 132 considers the chronological order and reliability of the educational data 146 to infer whether the student is in an unknown, learning, learned, or confirmed state of mastery. The mastery level determination system 132 prioritizes the most recent and reliable data to provide an accurate assessment of the student's current skill level.

The determined mastery states are then updated in the knowledge graph 1104, which serves as a centralized repository of the student's skill mastery across all educational standards. This knowledge graph 1104 is accessible to an educator 1106, who receives notifications or updates about the student's skill mastery through the online learning platform 102.

For instance, a student 1102, Rosie, actively engages with various learning apps 112 to improve her math skills. She starts using a new app focused on algebraic equations, where the categorization module 140 (not shown in the figure) initially records her skill level as ‘learning’. As Rosie progresses and consistently performs well in app-based quizzes, her skill mastery is updated to ‘learned’. Meanwhile, at school, she takes the internal assessments 108 which strengthens her understanding, further confirming her mastery status. Later in the semester, Rosie takes the external standardized math test 110. Her performance on the external test 110, which aligns with educational standards, serves as a verification of her skills across different contexts. The categorization module 140 updates her skill's state to ‘Confirmed’ based on this external validation.

If there are conflicting signals from different educational platforms 106 about Rosie's skill level, the mastery level determination system 132 (not shown in the figure) prioritizes the most reliable and recent data to ensure educators receive an accurate and comprehensive understanding of her progress. This approach enables educators to understand Rosie's learning experience more effectively based on her demonstrated strengths and areas needing improvement.

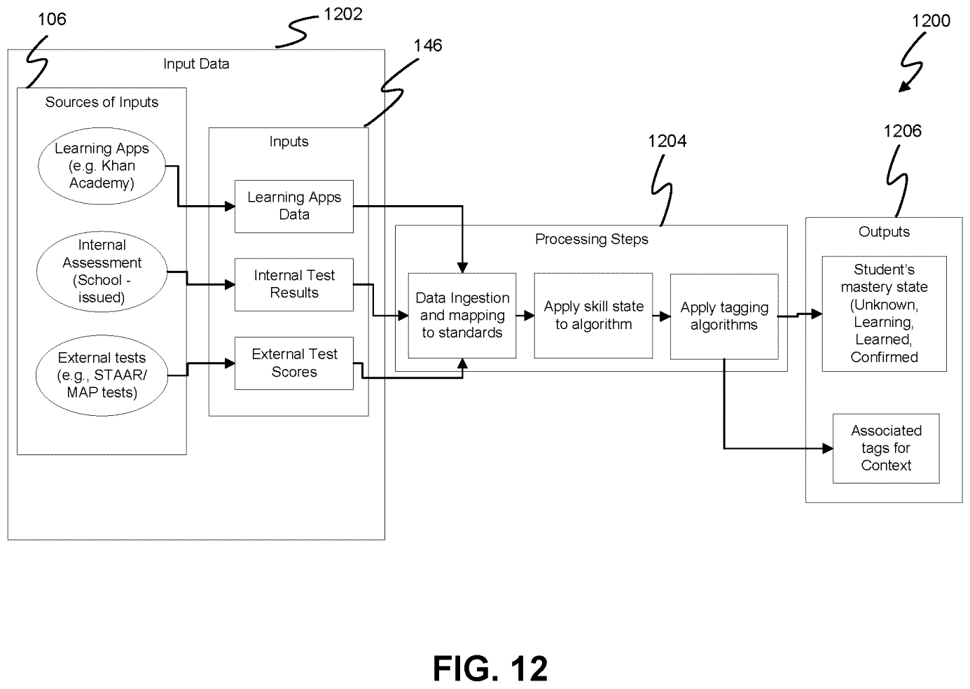

FIG. 12 depicts a student's mastery state and associated descriptive tags 1206 determining process 1200 which is an embodiment of the mastery level determining process 200 from the centralized mastery structure generated from external educational sources 106 of FIG. 2.

The student's mastery state and associated descriptive tags 1206 determining process 1200 illustrates processing and updating a student's mastery levels based on the educational data 146 from the various educational sources 106. The student's mastery state and the associated descriptive tags 1206 determining the process 1200 is divided into three main steps: Inputs, Processing Steps, and Outputs, each playing an important role in the functionality of the student's mastery state and associated descriptive tags 1206 determining process 1200.

The first step 1202, labeled Inputs, comprises of the three types of educational platforms 106 that feed the educational data 146 into the user educational data centralization module 118 (not shown in the figure). These include the Learning Apps Data 112, the Internal Test Results 108, and the External Test Scores 110. The educational data 146 originate from specific sources: learning apps like Khan Academy, internal assessments such as school-issued tests, and external standardized tests like STAAR (State of Texas Assessments of Academic Readiness) or MAP (Measures of Academic Progress) test. The diverse educational platforms 106 provide a detailed view of a student's performance across different educational contexts.

In the Processing Steps 1204, the collected educational data 146 undergoes a series of essential operations to ensure it is accurately categorized and enriched for insightful analysis. Initially, the educational data 146 is ingested and mapped to the educational standards, standardizing and normalizing the educational data 146 and aligning it with relevant educational benchmarks. This step ensures consistency and comparability across the different educational platforms 106. The data is then processed using the categorizing module 140 (not shown in the figure) through a skill state algorithm that evaluates the student's proficiency in various skills. This algorithm categorizes the student's knowledge into one of four mastery states: Unknown, Learning, Learned, or Confirmed. These categories signal the student's current mastery level, facilitating better understanding and tracking of their progress.

To further enhance the usefulness of the data, tagging algorithms are applied. These algorithms assign contextual tags to the mastery data, enriching it with additional information that can provide deeper insights into the student's learning status. Tags might include details about the context in which a skill was learned or additional notes on the student's performance trends. This tagging helps in creating a more comprehensive picture of the student's educational journey.

The outputs of these processing steps are presented in the Output step 1206 which includes the student's updated mastery state, reflecting their proficiency level in different skills. Additionally, the associated tags provide further context, offering educators a more detailed view of the student's learning progress. By combining the mastery state and contextual tags, the mastery level determination system 132 delivers a clear and comprehensive overview of the student's achievements and areas that may need further attention, thereby enhancing the overall effectiveness of educational interventions and personalized learning plans.

For instance, imagine Mary, a high school student passionate about physics, using various learning apps and taking both internal school tests and external assessments like the SAT Physics test. The collector 120 (not shown in the figure) collects the educational data 146 from the educational platforms 106, including her performance on mechanics, electromagnetism, and optics topics.

Once the educational data 146 is gathered, it undergoes standardization and mapping to educational standards relevant to physics. For example, if Mary excels in mechanics but struggles with electromagnetism based on her learning app activities and test scores, the categorization module 140 (not shown in the figure) categorizes her mastery states accordingly namely, ‘Learned’ for mechanics, and ‘Learning’ for electromagnetism. Additionally, tagging algorithms enrich this data by adding contextual tags, such as identifying Mary's strengths in problem-solving in mechanics and areas needing improvement in conceptual understanding of electromagnetism. These processes enable educators to gain a detailed understanding of Mary's proficiency in physics, facilitating personalized teaching approaches to support her learning journey effectively.

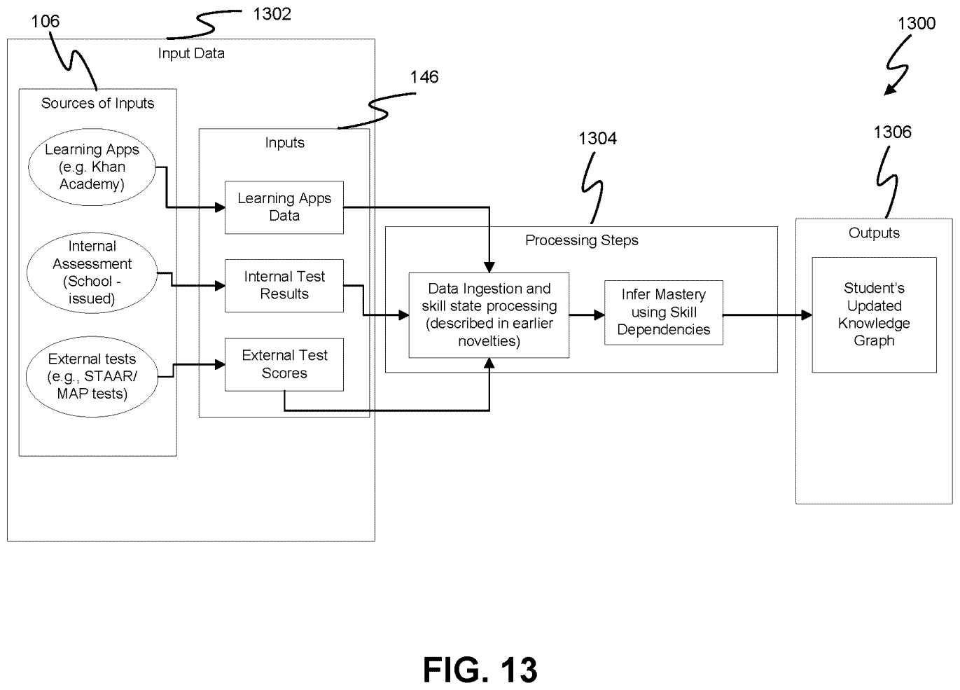

FIG. 13 depicts an updated knowledge graph 1306 generation process 1300 based on the educational data 146 collected from the different educational platforms 106, which is an embodiment of the mastery level determining process 200 from the centralized mastery structure generated from the external educational sources 106 of FIG. 2.

The updated knowledge graph 1306 generation process 1300 illustrates processing and updating a student's mastery levels based on educational data 146 from various educational sources 106. The updated knowledge graph 1306 generation process 1300 is divided into three main steps: Inputs, Processing Steps, and Outputs, each playing an important role in the functionality of the updated knowledge graph 1306 generation process 1300.

The first step 1302, labeled Inputs, comprises the three types of educational platforms 106 that feed the educational data 146 into the user educational data centralization module 118 (not shown in the figure). The educational data 146 include the Learning Apps Data 112, the Internal Test Results 108, and the External Test Scores 110. The educational data 146 originate from specific sources: learning apps like Khan Academy, internal assessments such as school-issued tests, and external standardized tests like STAAR (State of Texas Assessments of Academic Readiness) or MAP (Measures of Academic Progress) test. The diverse educational platforms 106 provide a detailed view of a student's performance across different educational contexts.

The second step 1304, Processing Steps, is where the core data processing occurs. Initially, data ingestion and skill state processing take place. This step involves collecting the educational data 146 from the various educational platforms 106 and transforming it into a format suitable for further analysis, ensuring consistency and standardization using a normalization module 122 (not shown in the figure). Following data ingestion and normalization, the mastery level determination system 132 utilize the machine learning algorithm that utilizes dependencies between different skills to infer mastery levels. This algorithm considers how mastery in one skill may impact or relate to mastery in another, providing a clear understanding of the student's knowledge state.

The final step Outputs 1306, terminates with the generation of the Student's Updated Knowledge Graph. This knowledge graph is a dynamic representation of the student's mastery levels, updated in real-time as new data is processed. It offers a clear, consolidated view of the student's current knowledge state, highlighting areas of strength and those needing improvement.

For instance, consider a student named Lily who uses a learning app like Khan Academy, takes internal math tests at her school, and participates in external standardized assessments like the MAP (Measures of Academic Progress) test. The user educational data centralization module 118 (not shown in the figure) collects her performance data 146 from these sources using the collector 120. In the processing steps, the data is standardized and analyzed using the machine learning algorithm, which might infer that Lily's proficiency in algebra supports her understanding of related skills like quadratic equations. This inferred mastery is then updated in Lily's knowledge graph, providing her teachers with an accurate, real-time overview of her educational progress.

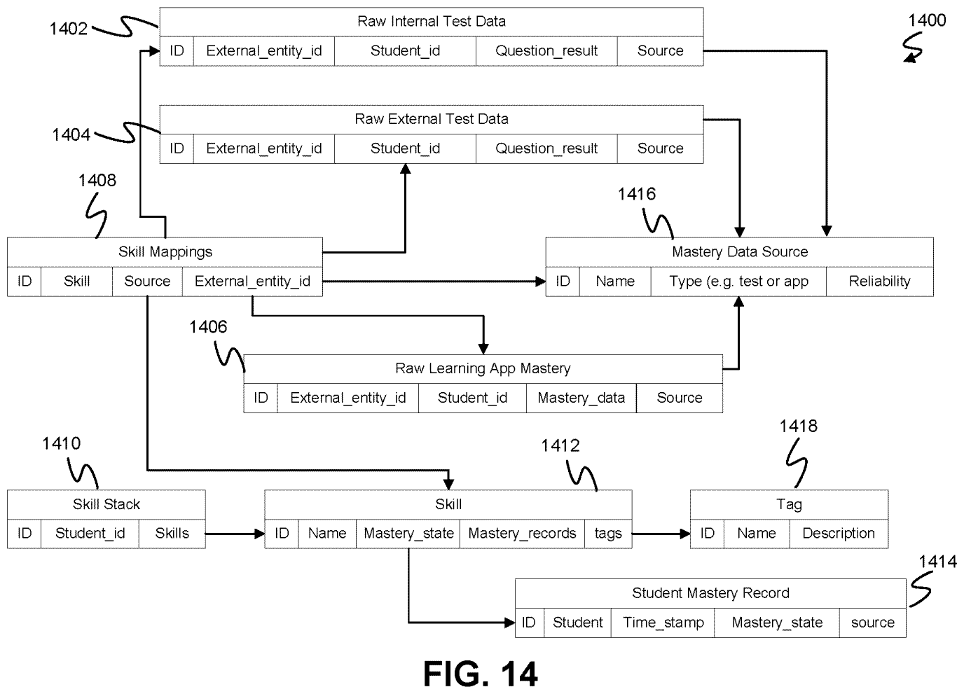

FIG. 14 depicts a data structure 1400 for organizing data to determine the mastery level of the user by collecting educational data from different educational platforms 106.

The data structure 1400 integrates the user educational data 146 from the plurality of educational sources 106 to present a unified view of student skills and mastery levels. The data structure 1400 is organized to efficiently link raw data from the different educational platforms 106, map skills, and track mastery records.

The data structure 1400 begins with nodes representing raw mastery data from the different educational platforms 106, including a raw internal test data 1402, a raw external test data 1404, and a raw learning app mastery 1406. Each of these nodes contains identifiers for the data, external entities, student identifiers, mastery data or question results, and the data source.

The data structure 1400 includes a Skill Mappings node 1408 which lies at the center of the data structure 1400 and is connected to all raw mastery data from the different educational platforms 106. The Skill Mappings node 1408 further maps the raw mastery data of the user to the corresponding skills. These mappings connect external entity IDs to their corresponding skills and sources, ensuring that each piece of raw data is appropriately linked to the skill it represents. The Skill Stack node 1410 collects the skills associated with each student, where each skill 1412 is detailed with an ID, name, mastery level, mastery records, and associated tags. Each skill's mastery records are linked to Student Mastery Records 1414, which include details about the student, timestamps, mastery states, and data sources.

The different educational platforms 106 are described in the Mastery Source node 1416, which includes IDs, names, types (such as internal or external tests or online learning apps), and reliability ratings, providing context for the reliability of the mastery data. Finally, tags 1418 associated with each skill provide additional descriptive metadata, enhancing the detail and context of the skills.

The data structure 1400 allows for a detailed and interconnected representation of student skills, mastery levels, and the origins of the data, facilitating complete analysis and tracking of educational progress.

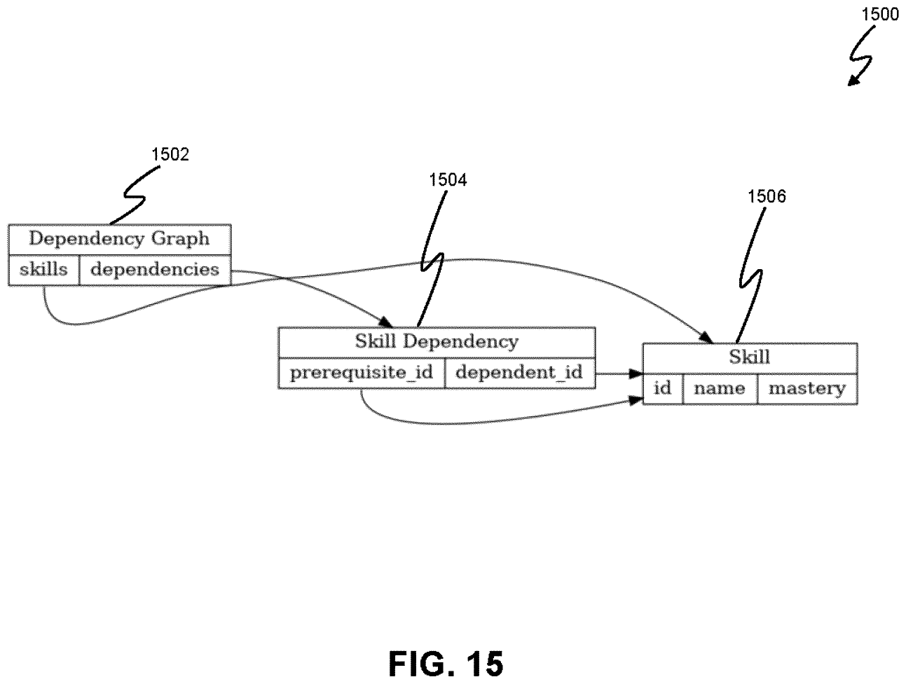

FIG. 15 depicts a data structure 1500 for organizing data to define the mastery and dependencies between the knowledge graph.

The data structure 1500 represents the dependencies between various skills and their associated mastery levels. The data structure 1500 consists of several key components and their interrelationships. Firstly, each skill 1506 is represented by a node containing an identifier (id), a name (name), and a mastery level (mastery), indicating the user's proficiency in that skill.

Additionally, the data structure 1500 includes a central component called a Dependency Graph 1502, which organizes all the skills and their dependencies. The Dependency Graph 1502 comprises two main parts: a collection of all the skill nodes (skills) and a record of dependency relationships between these skills (dependencies). Each dependency relationship is detailed in a Skill Dependency node 1504, which specifies the prerequisite and dependent skills through prerequisite_id and dependent_id, respectively.

These connections ensure that the Dependency Graph node 1504 points to the appropriate skill nodes and defines the prerequisites and dependencies among the skills. The data structure 1500 allows for a representation of how mastering one skill can influence the mastery of another, providing a clear understanding of the user's overall learning progress and the interdependencies of different skills.

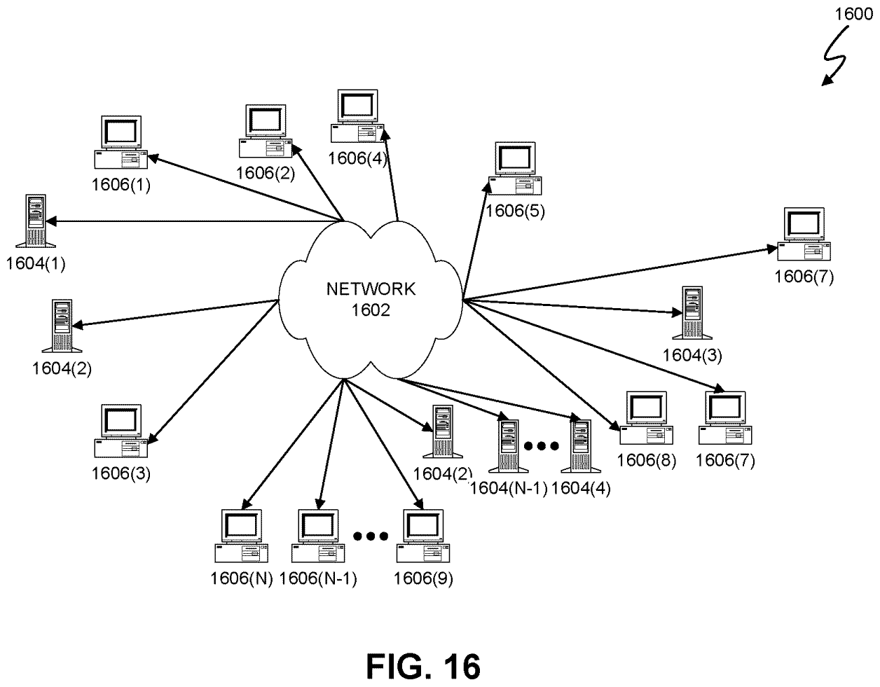

FIG. 16 is a block diagram illustrating a network environment in which a mastery level determining system 100 and process 200 from the centralized mastery structure generated from the educational data collected 146 from the external educational sources 106 may be practiced. Network 1602 (e.g. a private wide area network (WAN) or the Internet) includes several networked server computer systems 1604(1)-(N) that are accessible by client computer systems 1606(1)-(N), where N is the number of server computer systems connected to the network. Communication between client computer systems 1606(1)-(N) and server computer systems 1604(1)-(N) typically occurs over a network, such as a public switched telephone network over asynchronous digital subscriber line (ADSL) telephone lines or high-bandwidth trunks, for example, communications channels providing T1 or OC3 service. Client computer systems 1606(1)-(N) typically access server computer systems 1604(1)-(N) through a service provider, such as an internet service provider (“ISP”) by executing application-specific software, commonly referred to as a browser, on one of client computer systems 1606(1)-(N).

Client computer systems 1606(1)-(N) and/or server computer systems 1604(1)-(N) are specialized computers programmed to improve conventional computer systems to implement and utilize the mastery level determining system 100 and process 200 from the centralized mastery structure generated from the educational data collected 146 from the external educational sources 106. The type of computer system that can be specially programmed to implement and utilize the mastery level determining system 100 and process 200 from the centralized mastery structure generated from the educational data collected 146 from the external educational sources 106 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the mastery level determining system 100 and process 200 from the centralized mastery structure generated from the educational data collected 146 from the external educational sources 106 can be implemented using code stored in a tangible, non-transient computer-readable medium and executed by one or more processors. In at least one embodiment, the mastery level determining system 100 and process 200 from the centralized mastery structure generated from the educational data collected 146 from the external educational sources 106 can be implemented completely in hardware using, for example, logic circuits and other circuits including field programmable gate arrays.

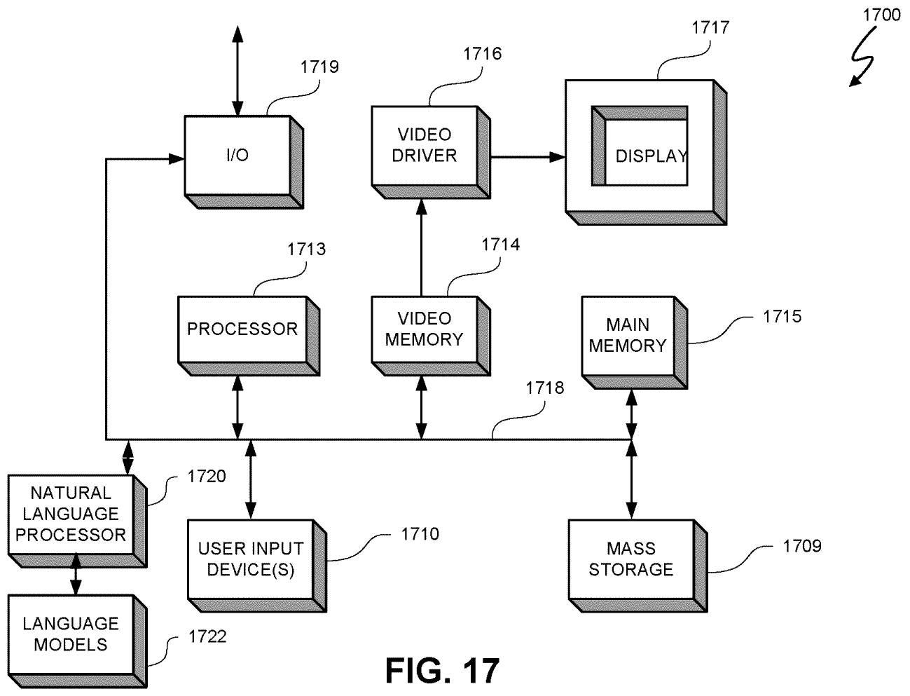

Embodiments of the mastery level determining system 100 and process 200 from the centralized mastery structure generated from the educational data collected 146 from the external educational sources 106 can be implemented on a computer system such as a special-purpose, special-programmed computer 1700 illustrated in FIG. 17. The input user device(s) 1710, such as a keyboard and/or mouse, are coupled to a bi-directional system bus 1718. The input user device(s) 1710 are for introducing user input to the computer system and communicating that user input to the processor 1713. The computer system of FIG. 17 generally also includes a non-transitory video memory 1714, non-transitory main memory 1715, and non-transitory mass storage 1709, all coupled to the bi-directional system bus 1718 along with input user device(s) 1710 and processor 1713. The mass storage 1709 may include both fixed and removable media, such as a hard drive, one or more CDs or DVDs, solid state memory including flash memory, and other available mass storage technology. Bus 1718 may contain, for example, 32 of 64 address lines for addressing video memory 1714 or main memory 1715. The system bus 1718 also includes, for example, an n-bit data bus for transferring DATA between and among the components, such as CPU 2009, main memory 1715, video memory 1714, and mass storage 1709, where “n” is, for example, 32 or 64. Alternatively, multiplex data/address lines may be used instead of separate data and address lines.

I/O device(s) 1719 may provide connections to peripheral devices, such as a printer, and may also provide a direct connection to a remote server computer system via a telephone link or to the Internet via an ISP. I/O device(s) 1719 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1709, into main memory 1715 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1713, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1715 consists of dynamic random access memory (DRAM). Video memory 1714 is a dual-ported video random access memory. One port of the video memory 1714 is coupled to the video amplifier 1716. The video amplifier 1716 is used to drive the display 1717. Video amplifier 1716 is well-known in the art and may be implemented by any suitable means. This circuitry converts pixel DATA stored in video memory 1714 to a raster signal suitable for use by display 1717. Display 1717 is a type of monitor suitable for displaying graphic images.

The computer system described above is for purposes of example only. The mastery level determining system 100 and process 200 from the centralized mastery structure generated from the educational data collected 146 from the external educational sources 106 may be implemented in any type of computer system or programming or processing environment. It is contemplated that the mastery level determining system 100 and process 200 from the centralized mastery structure generated from the educational data collected 146 from the external educational sources 106 might be run on a stand-alone computer system, such as the one described above. The mastery level determining system 100 and process 200 from the centralized mastery structure generated from the educational data collected 146 from the external educational sources 106 might also be run from a server computer system that can be accessed by a plurality of client computer systems interconnected over an intranet network. Finally, the mastery level determining system 100 and process 200 from the centralized mastery structure generated from the educational data collected 146 from the external educational sources 106 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method for determining whether the user has attained mastery or not by centralizing one or more user educational data from external educational sources, the method comprises:
executing code using one or more processors of a computer system to cause the computer system to perform operations comprising:
collecting the one or more user educational data from the external educational sources, wherein the one or more user educational data includes user mastery data from different online learning platforms, external assessments, internal quizzes, and so on;
normalizing the collected user educational data by defining each educational data based on standards of an educational curriculum, wherein the collected user educational data is ingested into a mastery structure to maintain uniformity across educational curriculums, and online learning platforms;
evaluating the most recent and reliable user educational data by determining the current mastery state for each skill by prioritizing more recent and reliable data over older and less reliable data;
calculating and assigning a reliability score and a recency score to each normalized educational data based on the trustworthiness, and timestamps of each of the educational data;
categorizing the user's mastery skills obtained from the normalized educational data to provide a clear representation of the user's knowledge level, wherein the categorized states include unknown, learning, learned, and confirmed; and
receiving a simplified mastery state and associated descriptive tag, wherein the mastery states and tags are accessible to the user via. an API (Application Programming Interface) to an online learning platform for further use in personalized learning experiences and assessments of the user.

2. The method of claim 1, wherein the educational data may include one or more topics studied by the user, questions attempted by the user, quizzes or tests taken by the user on external educational sources.

3. The method of claim 1, wherein the educational data may include quizzes or tests attempted by the user outside the learning platform environment.

4. The method of claim 1 wherein each of the user's educational data is timestamped to maintain a chronological record.

5. The method of claim 1 wherein the mastery structure is a structured framework designed to organize and represent user's mastery data consistently and uniformly across various educational platforms.

6. The method of claim 1 wherein standardizing the collected user educational data into a mastery structure further comprises:
collecting one or more user educational data from external educational sources;
transforming the collected user educational data into a predefined format to maintain uniformity;
mapping the user educational data fields from different educational sources to corresponding fields in the common mastery structure to facilitate seamless integration; and
storing the standardized data for further processing and analysis.

7. The method of claim 1 wherein normalizing the data to align with predefined educational standards further comprises:
identifying the educational standards that allow integration and converting the standardized data into a format that aligns with these predefined educational standards, ensuring that each data is appropriately categorized, wherein the educational standards include Common Core, NGSS, AP, and so on;
utilizing normalization techniques to adjust the data according to the difficulty levels, scopes, and contexts of the educational standards; and
storing the normalized mastery data of the user in a centralized cloud database, which consolidates data from various sources into a unified framework.

8. The method of claim 1 wherein evaluation and assignment of the recency score and the relevancy score to determine the mastery level of the user further comprises:
receiving user educational data from various online learning platforms, quizzes, and external assessments, with each data entry timestamped to indicate the time of acquisition;
utilizing machine learning algorithms to determine the recency of each data entry by comparing timestamps and prioritizing data entries with more recent timestamps to reflect the most current assessment of user mastery;
evaluating the relevancy of each educational platform based on predefined criteria, such as the educational context and the alignment with educational standards, and assigning the relevancy scores to each data entry to indicate its importance and applicability in assessing user mastery;
establishing weighting factors to adjust the impact of recency and relevancy scores on the overall assessment of user mastery; and
categorizing the mastery state of the user based on the generated scores.

9. The method of claim 1 wherein the recency score prioritizes data entries based on the most recent timestamps, ensures that recent assessments carry more weight in determining current mastery states.

10. The method of claim 1 wherein the relevancy score assesses the alignment of each educational data with predefined educational standards, ensuring that educational data directly contributes to the accurate assessment of user mastery.

11. The method of claim 1 further comprises:
utilizing machine learning techniques to optimize the algorithm for evaluating recency and relevancy scores, enhancing the accuracy and efficiency of determining the user's mastery levels.

12. The method of claim 1 automatically generates real-time feedback based on the assessed mastery states, providing targeted recommendations for further learning activities, practice, or assessments.

13. A system to determine whether a user has attained mastery or not by centralizing one or more user educational data from external educational sources, the system comprises:
one or more processors;
one or more databases, operatively coupled to the one or more processors that when executed cause the one or more processors to perform operations comprising:
collecting the one or more user educational data from the external educational sources using a collector, wherein the one or more user educational data includes user mastery data from different online learning platforms, external assessments, internal quizzes, and so on;
normalizing the collected user educational data using a normalization module by defining each educational data based on standards of an educational curriculum, wherein the collected user educational data is ingested into a performance matrix to maintain uniformity across educational curriculums, and online learning platforms;
evaluating the most recent and reliable user educational data by determining the current mastery state for each skill by prioritizing more recent and reliable data over older and less reliable data using an evaluator;
calculate and assign a reliability score using a reliability score calculator and a recency score using a recency score calculator to each normalized educational data based on the trustworthiness, and timestamps of each educational data respectively;
categorize the user's mastery skills obtained from the normalized educational data to provide a clear representation of the user's knowledge level using a categorization module, wherein the categorized states include unknown, learning, learned, and confirmed;
receiving a simplified mastery state and associated descriptive tags, wherein the mastery states and tags are accessible to the user via. an API (Application Programming Interface) to an online learning platform for further use in personalized learning experiences and assessments of the user.

14. The system of claim 13 wherein collecting educational data from the external educational sources further comprises utilizing the plurality of APIs by the data collector to collect educational data from the external educational sources.

15. The system of claim 13 utilizes a knowledge graph to infer mastery states for skills lacking availability of the direct educational data, thereby utilizing known mastery data of interdependent skills, and predicting the user's knowledge level based on the relationships between different skills using a predictor.

16. The system of claim 13 wherein the categorization module automatically updates the categorized states in real-time as new educational data is collected and processed, ensuring that the user's mastery levels are always current and updated.

17. The system of claim 13 wherein the normalization module includes a machine learning module configured to identify patterns and relationships between the educational data from the external educational sources and educational standards.

18. The system of claim 13 wherein the normalization utilizes machine learning algorithm for continuously improving the mapping accuracy between collected educational data and predefined educational standards.

19.

20. The system of claim 13 wherein a feedback module automatically generates real-time feedback based on the assessed mastery states, providing targeted recommendations for further learning activities, practice, or assessments.
